(19) United States
(12) Patent Application Publication
(10) Pub. No.: US 2006/0104739 A1
(43) Pub. Date: May 18, 2006

(54) Removable pickup truck bed tie down

(76) Inventor: Brian Elmer Hamper, Ferndale, CA (US)

Correspondence Address: BRIAN HAMPER, P.O. Box 1374, FERNDALE, CA, 95536, US

(21) Appl. No.: 10/988,353

(22) Filed: Nov. 15, 2004

(51) Int. Cl. B60P 7/12

(52) U.S. Cl. 410/34

(57) ABSTRACT

Remoov-A-Tie is a new style truck bed tie-down for securing materials being transported in the bed of a pickup truck. The unit is removable when not in use, cannot be pulled loose from the stake-hole in the bedrail, does not require drilling of truck-bed to mount it, andf utilizes a cleat versus an eyebolt, for easier use.

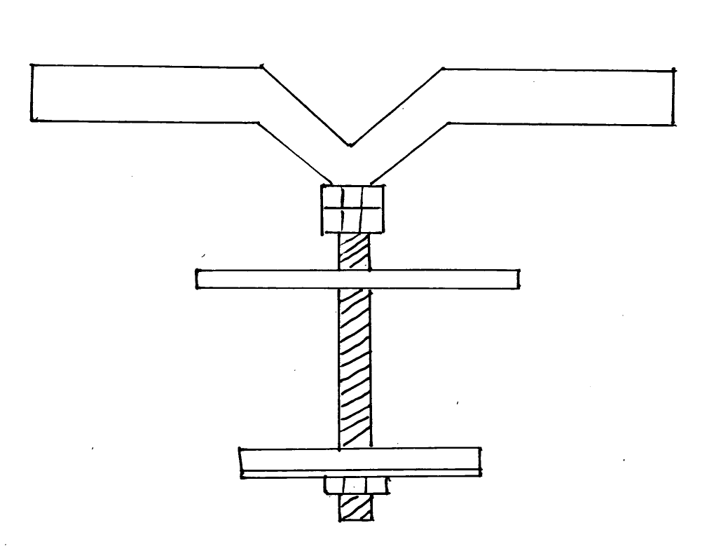

The Remoov-a-tie truck bed tie-down consists of four parts as described in subsections(A)-(D) below:
(A) This piece is “T” shaped, with a horizontal piece being either straight or bent (as shown in the drawing) as necessitated by manufacturing procedures. The vertical portion (except for the top half inch to one inch) is threaded, per manufacturing procedures.
(B) This is a snug nut placed at the top of the vertical threaded portion of part (A)
(C) Is a flat plate which is center drilled large enough to freely slide over the vertical portion of part (A)
(D) Is a flat plate which is center drilled and threaded and screws onto the vertical portion of part (A)

The unit can be manufactured from metal, molded from plastic, or a combination of both.

The unit is used by inserting part (D) into the stake bed hole on a pick-up truck bedrail, rotating it 90 degrees and pulling it upward, which prevents its removal. One then places two fingers under part (C) and while lifting upward turns part (A) Clockwise to snug part (C) against the top of the bedrail (must remove fingers gradually during this process). Once both plated (C ) and (D) are tight against opposing sides of the bedrail use a wrench to turn part (B) thereby fully securing the unit.

1. Unit is removable when not in use
No drilling of truck bed to mount it
Unit cannot pull loose
Utilizes a cleat vs. and eyebolt for easier use
Made of rustproof material
